(19) United States
(12) Patent Application Publication
(10) Pub. No.: US 2020/0250580 A1
(43) Pub. Date: Aug. 6, 2020

(54) AUTOMATED LABELERS FOR MACHINE LEARNING ALGORITHMS

(71) Applicant: Jaxon, Inc., Boston, MA (US)

(72) Inventor: Gregory Harman, Castro Valley, CA (US)

(73) Assignee: Jaxon, Inc., Boston, MA (US)

(21) Appl. No.: 16/725,841

(22) Filed: Dec. 23, 2019

Related U.S. Application Data
(60) Provisional application No. 62/800,254, filed on Feb. 1, 2019.

(51) Int. Cl. G06N 20/00

(52) U.S. Cl. CPC G06N 20/00

(57) ABSTRACT

Methods and apparati for continuous growth, re-use, and application of automated labelers 4, 7 for machine learning algorithms into ensembles 10. A method embodiment of the present invention comprises an iterative cycle (steps 11 through 15) in which data 2 is collected, indexed, and then used to create labelers 4 to generate training data for supervised and semi-supervised machine learning algorithms. A new set of unlabeled training data 5 is then similarly indexed and combined with the most similar, relevant, or useful previous labelers 4 by means of index 6, 3 comparisons in order to create an optimized ensemble 10 of labelers 4, 7, thus maximizing the training value of the labels generated from the labelers 4, 7.

### RELATED APPLICATION

This patent application claims the priority benefit of U.S. provisional patent application 62/800,254 filed Feb. 1, 2019, entitled “Method For Continuous Growth, Reuse, and Application of Automated Weak Labelers Into Ensembles”; this provisional patent application is hereby incorporated by reference in its entirety into the present patent application.

### TECHNICAL FIELD

This invention pertains to generating labels in the field of machine learning, a branch of artificial intelligence. Many machine learning algorithms, including those in the “supervised” and “semi-supervised” categories, require labeled training data as an input to the training (model generation) phase. The learning algorithms consume original data segmented into “examples” or “documents”, and learn patterns that help them predict the correct label. For example, a sentiment analysis algorithm might map an input document (e.g., a tweet) to a sentiment of “positive” or “negative” (the label). This algorithm would be presented with a set of tweets and human-provided annotations of “positive” or “negative” for each one. The algorithm would then learn how to classify new tweets as “positive” or “negative”.

### BACKGROUND ART

Adding labels to data for training purposes can be an expensive and time-consuming process, because this procedure generally needs to be manually performed, and because modern production-scale machine learning algorithms require enormous amounts of data for state-of-the-art results.

Weak labeling is one approach to solving this problem. In weak labeling, automation replaces human labelers at the cost of producing lower quality, or “noisy”, labels in which some unknown percentage of labels are “wrong”. It is still possible, if less accurate, to utilize these “weak labels” for some useful training activities.

The approach of pooling a set of weak labelers into an ensemble that exhibits near-parity with human-source labels has been examined in a number of places in practice and academic theory. One notable example is Snorkel (generically, “data programming”), which demonstrates this basic premise. [Ratner, A., Bach, S., Ehrenberg, H., Fries, J., Wu, S., Re, C. Snorkel: Rapid Training Data Creation with Weak Supervision https://arxiv.org/abs/1711.10160, 2017] One drawback of data programming is the need for humans to create weak labeling functions that produce the weak labels. This level of human involvement decreases the pool of available labelers and increases their cost (compared to, e.g., crowdsourced labeling) by requiring skilled programmers to produce the labeling functions. These labeling functions additionally risk the introduction of bias introduced by those programmers' preconceptions about the data.

A “productionized” version of Snorkel has been introduced as Snorkel DryBell, which demonstrates and validates the principles of data programming at scale. [Bach, S., et al., Snorkel DryBell: A Case Study in Deploying Weak Supervision at Industrial Scale. https://arxiv.org/abs/1812.00417, 2018] One notable conceptual addition is the need for coordination of multiple programmers across many projects and datasets. Snorkel DryBell describes a library of functions that can be searched and used as a repository for reuse of weak labelers. This implies a process for generating new labeled training data that involves a manual discovery and selection of weak labelers from this repository. This approach is necessarily labor-intensive and non-optimal in terms of selecting the most relevant or effective labelers, leaving human users to speculate and select based on trial-and-error. The functions enumerated in this paper make mention of topic models, but only as heuristic predictors and not as a means of indexing or as part of a more complex functional assembly as done in the present invention.

One means of addressing the need for human programmers to manually create weak labelers has been presented by an academic publication entitled Snuba. [Varma, P., Re, C. Snuba: Automating Weak Supervision to Label Training Data http://www.vldb.org/pvldb/vol12/p223-varma.pdf, 2019] Snuba utilizes heuristic-based approaches to generate data labeling functions, which are then sifted and combined in a generative fashion into a weak labeler. This is a positive first step towards addressing the dependency on human programmers. However, the scope and adaptability of heuristics is limited compared to first-class machine learning, and no means is presented in Snuba for effective automated reuse of already-developed weak labelers.

These prior approaches all utilize combinations of data functions to create a single labeler; the present invention additionally combines finished multiclass labelers into ensembles of labelers using novel techniques.

### DISCLOSURE OF INVENTION

This invention expands on the concept of creating an ensemble of labelers, overcoming the weaknesses of prior approaches described above, by incorporating the following features, thus providing novel and non-obvious solutions to the above-described technical problems.

Introduction of automatically-generated indices 6, 3 that are used to help identify an optimal set of candidate labelers 9 for a given ensemble 10.

The use of machine learning models, typically optimized for small-sample learning, as labelers 4, 7 in lieu of or in addition to heuristic or hand-coded labeling functions.

Automatic, weighted inclusion of individual labelers 9, 7 into an ensemble 10 based on comparison of the indices 3 for a pre-existing archive 1 of candidate labelers 4 with the index 6 created for a new (target) labeler 7 directly derived from a new unlabeled dataset 5.

### BRIEF DESCRIPTION OF THE DRAWINGS

These and other more detailed and specific objects and features of the present invention are more fully disclosed in the following specification, reference being had to the accompanying drawings, in which:

FIG. 1 is a flow diagram illustrating a method embodiment of the present invention.

FIG. 2 is a flow/status diagram illustrating an embodiment of the present invention in which a new labeler D is added to an ensemble 10.

FIG. 3 is a flow/status diagram illustrating an embodiment of the present invention in which a final ensemble 10 of labelers is compiled from target labelers 7 and candidate labelers 4.

FIG. 4 is a block diagram showing modules 43, 44, 45, 49 used in embodiments of the present invention.

### DETAILED DESCRIPTION OF PREFERRED EMBODIMENTS

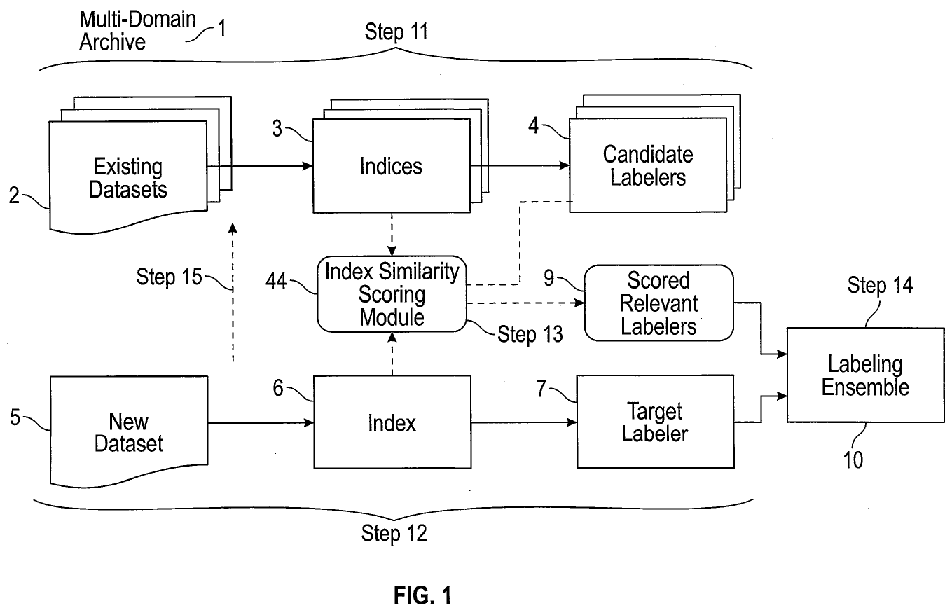

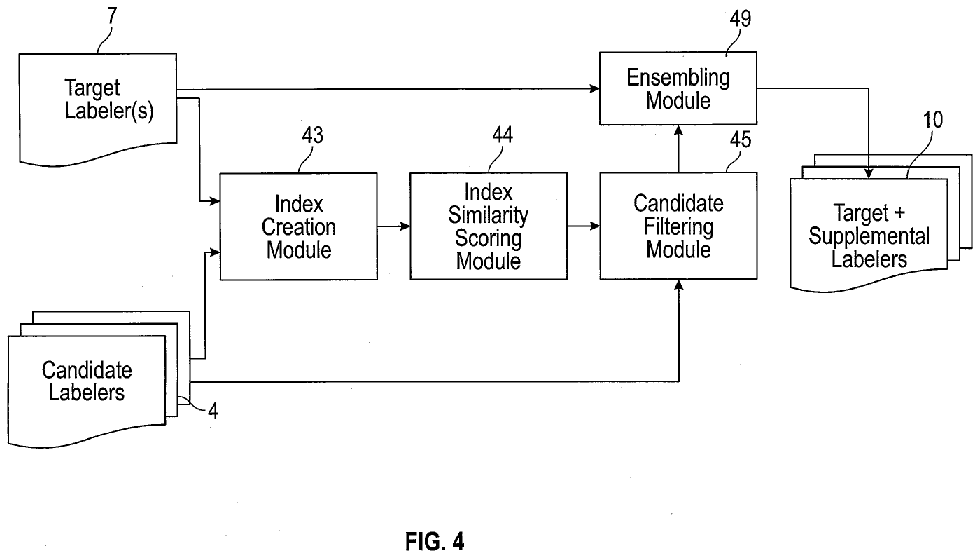

In step 11 of FIG. 1, a collection (archive) 1 of existing datasets 2 is processed by an index creation module 43 (see FIG. 4) to derive an index 3 for each labeler 4 associated with the dataset 2. The process of creating indices 3 is described below, and examples of indices 3 are given. As used herein, the term “labeler” means a software module 4 that is configured to generate labels for unstructured examples in a dataset 2. Labelers 4 may take the form of human-crafted or automatically derived heuristics, or machine learning models (e.g. semi-supervised modeling approaches) that learn and infer labeling logic from a provided training dataset 2. This may have been done in advance of a given labeling project in order to create an archive 1 of indices 3 and labelers 4. These datasets 2 may span across sources, domains, or other data structures; step 11 is not limited to any particular machine learning problem, but rather has broad applicability to a wide variety of labeling contexts. As used herein, a “domain” is an informational subject area, such as “retail sales” or “medical research”. One effective approach to deriving labelers 4 involves parameterizing the training and architecture of the labelers 4 using an evolutionary algorithm that utilizes a sample of the original (“ground truth”) dataset 2 as the basis for a fitness function that evaluates on criteria such as accuracy of the ensuing labels, coverage of the data domain, and evaluation cost.

In step 12 of FIG. 1, a new dataset 5 comprising specific sample data intended to be applied to a target machine learning problem is presented to the user. This dataset 5 typically includes a mix of a few pre-labeled examples (i.e., produced by weak supervision), but may optionally include additional unlabeled examples. An index creation module 43 creates both an index 6 for new (“target”) labeler 7, and enhances (improves the accuracy of) the derived labeler 7. The relationship among items 5, 6, and 7 is the same as the relationship among any single instance of items 2, 3, and 4. Note that step 12 is identical to the process used by module 43 for a single dataset 2 from step 11, and in fact dataset 5 can be blended back into archive 1 for one or more subsequent iterations of the overall FIG. 1 process, in step(s) 15.

In step 13 of FIG. 1, the indices 3 for each of the candidate labelers 4 are compared against the index 6 for the new target labeler 7 by activating index similarity scoring module 44, and then invoking candidate filtering module 45 to filter the labelers 4 chosen by module 44, based on scoring criteria such as domain or topical relevance, accuracy when applied to the new dataset 5, and/or computational cost, resulting in a scored (possibly weighted) subset of filtered labelers 9 that are retained for step 14. The number of candidate labelers 4 is thus advantageously reduced when included in the set of scored filtered labelers 9, minimizing redundancy and conserving computer resources.

In step 14 of FIG. 1, a combination of the highest-scoring (e.g., most relevant) labelers 9 identified in step 13 along with the new data-specific target labeler 7 generated in step 12 are combined by ensembling module 49 of the present invention, in order to create an aggregate labeler, i.e., labeling ensemble 10. One example of an ensembling scheme 14 is called “majority vote”. In this scheme 14, the same example input data is presented to each labeler 9, with the labeler 9 associated with the most common predicted label being selected for inclusion in ensemble 10. This scheme 14 can be further enhanced/modified by weighting votes based on confidence scores or subdomain relevance, and/or by supporting the abstention of votes for low-confidence predictions by individual labelers 9.

In step 15 of FIG. 1, the new index 6 and corresponding labeler 7 are added to archive 1 in order to iteratively feed this collection 1, allowing better topical and domain coverage, and increasing the pool of available labelers 4 for possible subsequent iterations of step 15. Note that the starting dataset 2 used to create the set of indices 3 and labelers 4 can optionally be discarded at this juncture, as only the indices 3 and labelers 4 are used for subsequent iterations of the overall process of FIG. 1. This allows not only a reduction in required computer storage capacity, but may be necessary in the event that the dataset 2 cannot be legally retained due to policy, privacy, ownership, or other reasons. The FIG. 1 process can be initiated with an empty archive 1, with step 15 serving to populate that archive 1. The value and breadth of the archive 1 grows in perpetuity; the practical limit to archive 1 size is based on the amount of computer storage required for archive 1; and the cost of computation to create the archive 1 and to analyze and assess indices 3 for each archived labeler 4 upon the addition or utilization of a new labeler 7.

### Ensembling

The present invention functions using a variety of labelers 4, 7. The referenced Snorkel paper and other works in the technical literature establish the general principle that an ensemble of labelers can not only outperform any individual labeler, but can also approach the accuracy of human-provided labels. The specific choices of labelers should strike a balance between computational efficiency, (lack of) informational overlap, and sensitivity to noise. This implies:

The number of labelers 4 from archive 1 should be minimized as ensemble 10 is created, to reduce redundancy. In other words, a “brute force” approach of using all labelers 4 from archive 1 should not be used.

The selected candidate labelers 4 should be weighted and focused on subsections of the data 5 for which they offer the best signal/noise ratio.

To support this, a measure of variety among the selected labelers 4 should be high, implying not only a variety in labeler 4 heuristics and algorithms, but also variety in the informational domain which the labelers 4 cover (implied, to a degree, by the dataset 2 and problem that was originally used to derive the labelers 4).

If an optimal ensemble 10 (a subset of labelers 4 plus labeler 7, which combine their individual predictions into a consensus prediction) can strategically weight each individual labeler 4, 7 for a particular subsection of the domain, said ensemble 10 can also identify those areas of the domain that are poorly covered by the current ensemble 10, and either proactively seek an appropriate labeler 4 from archive 1 to be added to the ensemble 10, or else define the scope of such a new labeler (in terms of dataset/sub-domain, heuristic/algorithm, etc.) as a specification for a high-value future iteration (i.e., for a human administrator to schedule for the overall system). The prior art does not even suggest this feature; the present invention performs it.

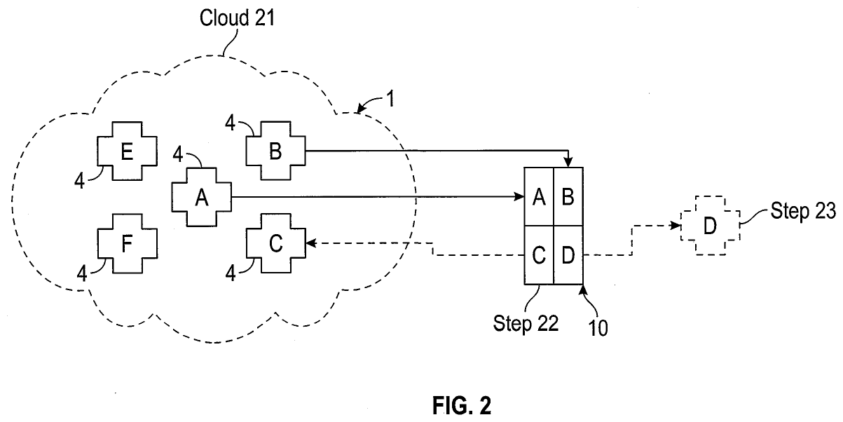

Cloud 21 of FIG. 2 illustrates the status of archive 1 prior to implementation of the present invention. Five labelers 4 are shown as residing within archive 1. These labelers 4 are identified by the letters A, B, C, E, and F; and are highly coupled to given datasets 2. For purposes of illustration, let us assume that dataset 2 comprises a set of recipes for preparing Latin American food items. The relevant domain is therefore “Latin American food”. An under-addressed sub-domain, associated with labeler C, is detected in archive 1 by index similarity scoring module 44. “Under-addressed” means that the sub-domain in question has labelers 4 that cover the sub-domain, but not as many labelers 4 as other sub-domains in the given domain. In our example, let's assume that index 3 has strength (i.e., many labelers 4) for the sub-domain “Mexican food”. This implies that there is a sub-domain of the domain “Latin American food” that does not have good coverage, i.e., it is under-addressed. Index similarity scoring module 44 notices this fact, and also notices that there is an index 3/labeler D associated with the sub-domain “Brazilian food”. At step 23, module 44 automatically adds labeler D to ensemble 10. In an alternative embodiment of step 23, module 44 notices the domain coverage gap, and defines the specification for a new labeler that will fill the gap. This new labeler can then be added to archive 1, where it can be re-used.

As stated previously, one embodiment of ensemble construction 14 comprises a voting scheme, in which the majority vote (of a given label for a given dataset 2 input) is used to select the corresponding labeler 9 to add to ensemble 10, possibly with weights derived from the scores. A more sophisticated ensembling technique 14 adapts these weights contextually over particular subsections of the data domain based on a given labeler's area of “expertise”, defined as the subsection of data over which that labeler 9 is most accurate. Determination of such combined weighting can itself be implemented as a machine learning function that estimates the labeler 9's contextual score based on strategic sampling of the available ground-truth labels (or the application of zero-shot or noise-aware estimation techniques, such as those that exist in the technical literature).

Another embodiment for optimizing ensemble parameters (factors such as voting weights and scheme) involves the application of an evolutionary algorithm to “grow” a given ensemble 10 over time, evaluating its fitness against a known good training set.

### Indices, Filtering, and Labeler Selection

A key issue with an archived labeler library, such as that described by Snorkel DryBell, is that over time such an archive will grow much larger than is optimal. Including all available labelers not only becomes inefficient (using more computational resources than necessary for a useful result), but may actually degrade the overall output.

In order to address this problem, we want each ensemble 10 in the present invention to include an optimized, scored subset of available labelers 9. An index 3 is created by index creation module 43 for each archived labeler 4 (step 11 of FIG. 1), and an index 6 is created by index creation module 43 for brand new labeler 7, which emanates from dataset 5 deemed representative of a specifically desired training set. Note that this new labeler 7 might be a renewed version of a pre-existing labeler 4 (a subset, a re-application of ground truth labeling, etc.), or may be completely novel to the overall system; for purposes of this invention, even derived versions of existing artifacts are considered “new”.

Here are examples of indices 3. A very simple index 3 for a cookbook A dataset 2 might include the following two (of many) topics:
1. [apple banana cactus_fruit orange]
2. [cake dessert pastry pie]
and these three out of possibly more labels: [American French Italian]
This index 3 might be a good match for an index 3 based upon a model B dataset 2 that might contain the following topics/labels:
1. [apple banana carrot sugar]
2. [breakfast dessert dinner high_tea lunch]
Labels: [American English French]
And a poorer match for an index 3 based upon a model C dataset 2 that might contain the following topics/labels:
1. [apple facebook google microsoft]
2. [capital revenue p&I]
Labels: [Automotive Banking Retail Technology]
Using an (overly-simplified for illustration) scheme of comparing common words, the indices 3 for A and B share five keywords across two topics and the label set, whereas A and C share only one keyword in one topic and no common labels. Hence, the index 3 for A is a “good match” to the index 3 for B, and a “poorer match” to the index 3 for C.

One possible method for indexing labelers 4 associated with text data 2 (or other types of data 2 that can be represented as text (e.g., captioning of images), or directly as embeddings (e.g., X2Vec-style encoding schemes) which can then be clustered into “topics”) involves deriving topic models from the available training data 2, including examples with and without ground-truth labels. These topic models might be alternately produced by techniques such as LDA (latent dirichlet allocation) or LSI (latent semantic indexing). In the present invention, this topic-model method has been implemented as a multi-step process that includes embedding tokens (i.e., words or phrases) into a multi-dimensional vector space and then clustering points within that space into “topics”.

These topic models are then combined with the set of ground-truth labels known for that particular dataset 2 to constitute the index 3. In some permutations of this scheme, these labels themselves can be directly embedded into the same vector space and topic model.

In addition to the relevance filtering performed by candidate filtering module 45, a desirable diversity among labelers 9 can be ensured by programming index similarity scoring module 44 to score candidate labelers 4 based on lack of overlap with each other of the best labeler candidates B and B′ from archive 1, and by creating separate categories based on the labeling technique/architecture as a separate filtering facet from the topical domain; this categorization also forms an optional part of the indexing scheme.

Note that this scheme allows for the inclusion of externally-produced labelers 7 into archive 1 or into a “real-time” ensemble 10 so long as a compatible index 3 can be presented for each of those external labelers 7.

Finally, note that this index matching scheme can be applied in reverse by index similarity scoring module 44 to create specifications for specific “synthetic” labelers to add to ensemble 10 to address sparsely-covered areas of the problem domain, as mentioned above. Such areas can be topical, algorithmic, or other facets. These specifications can then be used by human curators to obtain relevant datasets 2 and to generate labelers 4 from them; or to drive an automated crawler or search engine to find appropriate data 2 and then generate an appropriate labeler 4 from that data 2.

### Alternative Implementation of Indexing/Filtering Scheme

An alternative implementation for the indexing method makes use of probabilistic labels. A classification model (labeler 4) outputs “soft labels” for each example that indicates a probability distribution over all possible labels; this probability distribution can also be conceptualized as a measure of the model's confidence that each label is the correct one.

Comparison of the probability for a given label versus an alternative label (for a particular example) can yield useful information, based on factors such as:
The difference in confidence—did label A barely edge out label B as the top choice, or was it overwhelmingly selected?
Identification of “near-miss” second and third place answers and global analysis of common points of confusion. Using cuisine identification as an example, it may be that Italian and Mediterranean cuisines are often confused, whereas Chinese cuisine is seen as relatively distinct. In mathematical terms, there is a manifold between Italian and Mediterranean along which many data points lie.
Most real-world datasets 2 carry a degree of labeling noise, and the latent (correct) label distribution (from which a machine learning model would learn) is not identical to the actual labels provided in that dataset 2. It is possible (through various existing mechanisms, such as calibration techniques and “confidence learning”) to estimate the latent distribution and use it to correct resulting errors.
The present invention utilizes this correction capability in a different capacity. By understanding the probable latent distribution of labels, and through that, the confidence in the correctness of any one specific label, the present invention creates a similarity metric usable as an index by:
Invoking index similarity scoring module 44 to compare latent label distributions between a target labeler 7 (or its underlying dataset 5) and a candidate labeler 4.
Using the label distribution from the target labeler 7, having candidate filtering module 45 filter which candidate labelers 4 should be selected for inclusion in ensemble 10. For example, if more than X % (where X is some configurable threshold) of labels that were passed into the candidate labeler 4 agree with the filter, the candidate labeler 4 is deemed to be a match, i.e., worthy of addition to ensemble 10.
Again using the label distribution from the target labeler 7, the present invention can use a candidate labeler 4's underlying dataset 2 (NOT the candidate labeler 4 itself in this instance) to filter unrelated examples, creating a subset of the candidate dataset 2 that is pertinent to the target labeler 7, and then retrain a new candidate labeler 4 based on this filtered dataset 2.

Note that this technique is not mutually exclusive with the previously mentioned topic-modeling based approach, and that both techniques can be combined into a bifurcated index 3. Indeed, any number of similarity indexing schemes can be aggregated for this purpose.

Note also that, unlike the topic-modeling scheme, which is largely oriented towards text data 2, this alternative indexing scheme is general in nature, and can apply to any type of data 2 being classified.

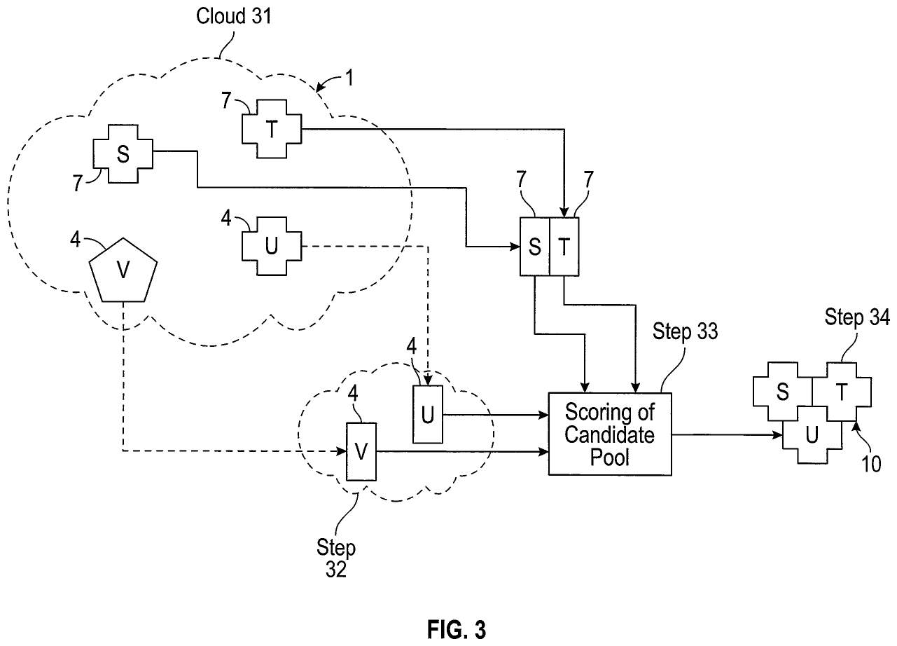

The selection of relevant (to dataset 5/index 6/labeler 7) labelers 4 can be executed by including in the present invention a recommendation engine comprising modules 44 and 45 of FIG. 4. Modules 44, 45 are one or more software, firmware, or hardware modules that perform step 33 of FIG. 3. While there are many applicable recommendation architectures in existence that can be used to perform this role, a straightforward approach is to configure the recommendation engine 44, 45 to perform comparisons and relevance scoring of indices 3, 6 using similarity computations between the index 6 for target labeler 7 and index 3 for a candidate labeler 4.

In FIG. 3, cloud 31 illustrates the status of archive 1 before implementation of the present invention. There are four labelers 4 shown as being part of archive 1—labelers S, T, U, and V. Labelers S and T are selected by the user to be target labelers 7, and are indexed. In an alternative embodiment labelers S and T are not part of archive 1, but rather are selected from some other source. Labelers U and V are candidate labelers 4, i.e., the present invention will determine whether labelers U and V deserve to be part of the particular ensemble 10 that is being compiled. This determination is made at step 33, and is made by index similarity scoring module 44 and candidate filtering module 45, which are described in conjunction with FIG. 4. In the illustrated example, modules 44 and 45 determine that labeler U is a match, but labeler V is not a match. In step 34, the ensemble 10 is compiled by ensembling module 49, by adding labeler U to labelers S and T. Since labeler V was not a match, V is not included in ensemble 10.

The modules used to perform the method of FIG. 3 are shown in FIG. 4, and can be implemented in any combination of hardware, firmware, and software. When implemented in software, these modules can reside on one or more disk, chip, or any other computer-readable medium.
1. Index Creation Module 43. Module 43 creates indices 3, 6 by applying an indexing scheme to target labeler 7 and to all candidate labelers 4 in the archive 1. In some embodiments, there are two modules 43, one for operating on dataset 2 and the other for operating on dataset 5. The indexing scheme might be one of, or a combination of, the topic modeling-based scheme and the label probability distribution scheme described above, or any combination involving other suitable indexing schemes. It is possible to compute index 3, 6 one time for each labeler 4, 7 (i.e., when the labeler 4, 7 is first created or imported into archive 1).
2. Index Similarity Scoring Module 44. Module 44 chooses one or more target labelers 7 as the basis for a new classification ensemble 46. The index(es) 6 from the target labeler(s) 7 are used by module 44 as a baseline against which the indices 3 from all candidate labelers 4 are scored, based on similarity to the target labelers 7. “Similarity to” implies a conceptual overlap between indices 3 and 6, but not an identical match. For example, index 3 may be a strategic extension of index 6.
3. Candidate Filtering Module 45. Module 45 filters all candidate labelers 4 (which now have a score against the specific target labeler(s) 7), to a smaller, more manageable number for the ensembling process 14. This scoring can be based on a configured similarity threshold, and can be further filtered on a Top-N basis as an upper limit, while still meeting the configured similarity threshold. The result of the filtering is a new ensemble 10, comprising the target labeler(s) 7 and at least one labeler from the set of candidate labelers 4.
4. Ensembling Module 49. Module 49 compiles the final ensembles 10, as discussed above.

### Advantages of the Present Invention

In summary, the present invention offers the following advantageous features when compared with the prior art:
1. A means for indexing and combining multiple labelers 4, 7 into an ensemble of labelers 10. This improves predictions for machine learning training data, or serves as direct predictors.
2. The aggregation of existing candidate labelers 4 into a collection that is later selectively filtered or queried in an automated fashion to select one or more of these labelers 4 to apply to a given machine learning problem.
3. The use of topic models or clustered embeddings (i.e., tokens projected to a vector space) as the basis for comparing the capabilities and domain coverage of a labeler 4 or other machine learning algorithm.
4. The use of an indexing system that describes the coverage of a given labeler 4, 7 or machine learning model in order to identify and specify functional or topical gaps.
5. The use of such a specification to locate or identify specific training data that may be used to generate a labeler 4, 7 or machine learning model that can be applied to address such a gap.

The above description is included to illustrate the operation of preferred embodiments, and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. Apparatus for determining whether one or more labelers from a set of candidate machine learning labelers should be combined with a target machine learning labeler, said apparatus comprising:
at least one index creation module configured to generate an index for each of the candidate labelers and for the target labeler;
coupled to the at least one index creation module, an index similarity scoring module configured to compare the indices associated with each candidate labeler against the index associated with the target labeler, and to produce a similarity score for each candidate labeler;
coupled to the index similarity scoring module, a candidate filtering module configured to reduce the set of candidate labelers based upon their similarity scores, thereby producing a set of filtered candidate labelers; and
coupled to the candidate filtering module and to the target labeler, an ensembling module configured to compile an ensemble of labelers comprising the target labeler and the filtered labelers.

2. The apparatus of claim 1 wherein at least one index creation module uses a topic-modeling based method to generate indices.

3. The apparatus of claim 1 wherein at least one index creation module uses a probabilistic approach to generate indices, said approach comparing the probability for a given label versus an alternative label.

4. The apparatus of claim 1 wherein the index similarity scoring module is configured to detect an under-addressed sub-domain associated with a candidate labeler.

5. The apparatus of claim 4 wherein the index similarity scoring module automatically adds a new labeler to the ensemble to compensate for the under-addressed sub-domain.

6. The apparatus of claim 4 wherein the index similarity scoring module is configured to define a specification for a new labeler that will compensate for the under-addressed sub-domain.

7. The apparatus of claim 6 wherein the specification is used by a human curator to obtain relevant datasets to generate labelers from said datasets.

8. The apparatus of claim 6 wherein the specification is used to drive an automated crawler or search engine to find appropriate data and then to generate an appropriate labeler from said data.

9. A method for creating an ensemble of machine learning labelers, said method comprising the steps of:
selecting a set of candidate labelers associated with a dataset in an existing archive;
generating an index for each candidate labeler;
selecting at least one target labeler from a new dataset;
generating an index for said target labeler; and
comparing the indices of each candidate labeler against the index for the target labeler, thereby producing a similarity score for each candidate labeler.

10. The method of claim 9 further comprising the steps of:
producing a subset of high scoring labelers from among the set of candidate labelers; and
combining the high scoring labelers with the target labeler to produce a labeling ensemble.

11. The method of claim 10 wherein the scoring is based on a configured similarity threshold.

12. The method of claim 11 wherein high scoring candidate labelers are further filtered on a Top-N basis as an upper limit, while still meeting the configured similarity threshold.

13. The method of claim 10 wherein the combining step comprises a majority vote method, wherein the same example input data is presented to each candidate labeler, with the candidate labeler associated with the most common predicted label being selected for inclusion in the ensemble.

14. The method of claim 13 wherein the majority vote method is modified by weighting votes for candidate labelers based upon at least one of the following two criteria:
confidence scores or sub-domain relevance;
abstention of votes for low-confidence predictions by individual candidate labelers.

15. The method of claim 9 wherein the new dataset, the target labeler, and the target index are added to the existing archive.

16. The method of claim 9 wherein the index similarity scoring module detects an under-addressed sub-domain associated with a candidate labeler.

17. The method of claim 16 wherein the index similarity scoring module automatically adds a labeler to the ensemble to compensate for the under-addressed sub-domain.

18. The method of claim 9 wherein the index similarity scoring module defines a specification for a new labeler that will compensate for the under-addressed sub-domain.

19. The method of claim 9 wherein the index generating step comprises a combination of the following two methods to generate indices:
a topic-modeling based method; and
a probabilistic method wherein the probability that a candidate labeler will produce a given label is compared with the probability that the candidate labeler will produce an alternative label.

20. At least one computer readable medium comprising computer program instructions for creating an ensemble of machine learning labelers, said instructions comprising the steps of:
selecting a set of candidate labelers associated with a dataset in an existing archive;
generating an index for each candidate labeler;
selecting at least one target labeler from a new dataset;
generating an index for said target labeler; and
comparing the indices of each candidate labeler against the index for the target labeler, thereby producing a similarity score for each candidate labeler.
